(19) United States
(12) Patent Application Publication
(10) Pub. No.: US 2002/0092898 A1
(43) Pub. Date: Jul. 18, 2002

(54) Process for connecting the winding wire of a coil with a terminal pin

(76) Inventors: Dieter Proksch, Moembris (DE); Norbert Nykrake, Sulzbach (DE); Dietmar Tempel, Bruchkobel (DE); Harald Hundt, Dieburg (DE)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/004,255

(22) Filed: Nov. 2, 2001

(30) Foreign Application Priority Data
Nov. 8, 2000 (DE) 100 55 178.5

(51) Int. Cl. B23K 31/02; B23K 35/12

(52) U.S. Cl. 228/256; 228/219; 228/220

(57) ABSTRACT

A process for connecting a winding wire of a coil with a terminal pin of a casing for surface mounting is introduced, whereby one end section of the winding wire is wound around the terminal pin. The area of the terminal pin wound with the end section of the winding wire is soft-soldered, and the soft-solder is then blown off of the partial area of the area wound, which forms the soldering application surface for surface mounting. The inventive process can be used in the manufacture of inductive SMD components, the terminal pins of which possess excellent coplanarity, particularly if terminal pins bent in a wing-shape are used.

### CLAIM TO PRIORITY

This application claims priority to German Patent Application No. 100 55 178.5 filed on Nov. 8, 2000.

### BACKGROUND OF THE INVENTION

1. Field of the Invention

The invention relates to a process for connecting a winding wire of a coil with a terminal pin of a component, particularly of an inductive component for surface mounting, whereby one end section of the winding wire is wound around the terminal pin and then soft-soldered. Such a process is known, for instance, from U.S. Pat. No. 6,073,832.

2. Description of the Related Art

Connections exist in the area of inductive components for surface mounting of so-called SMD components (SMD=surface mounted device), which are firmly positioned in a casing usually consisting of plastic. The rear ends of the terminal pins are not imbedded in the material of the casing. The end sections of the winding wires are wound around these rear ends of the terminal pins, and then soft-soldered to form a connection. Typically, these terminal pins are bent in a wing-like shape (Gull-Wing terminal pins).

This offers the benefit that the opposite ends of the terminal pins, which protrude from the casing and are intended for surface mounting, do not come in contact with softsolder before the actual surface mounting process, and therefore possess an optimum of coplanarity.

On the other hand, the rear ends of the terminal pins require substantial room within the casing in order to optimally be soldered to the end sections of the winding wires.

Accordingly, such inductive SMD components are not optimized with regard to their component volumes.

An additional design consists of leaving the terminal pin ends inside of the plastic casing. The end sections of the winding wires are then wound around the rear area of the terminal pins protruding from the casing, and then soft-soldered to form a connection. In this design, these terminal pins typically are also bent in a wing-like shape (Gull-Wing terminal pins).

Although this process is optimized with regard to the component volume, its greatest disadvantage is that the soft-solder covers the entire terminal pin protruding from the casing, and therefore impairs the coplanarity of the individual terminal pins.

Due to the fact that the solder application on all terminals of an individual component occurs irregularly, a substantially worse coplanarity is always present in comparison to the first procedure named above. Previously, attempts to remedy this situation were made by performing the following procedural steps, so-called “imprint steps.” The soft-solder applied is “flattened” in these “imprint steps.” However, this often leads to the winding wires being damaged by the mechanical load applied to them at the individual soldering points, and this results in at least long-term interruptions of the contact between the winding wires and the terminal pin so that this can generally lead to a total component failure.

### SUMMARY OF THE INVENTION

The task of the invention at hand is therefore to make available a substantially improved process of the type mentioned above, in which an excellent coplanarity of the individual terminal pins protruding from the component casing is ensured, and the “imprint steps” mentioned above are no longer necessary.

This task relating to the invention is solved by a process for connecting a coil winding wire with a terminal pin of a casing for surface mounting, whereby one end section of the winding wire is wound around the terminal pin in the following steps:

The area of the terminal pin wound with the end section of the winding wire is soft-soldered, and

The soft-solder is blown off of that partial area of the wound area, which forms the solder application surface for surface mounting.

The irregular solder application surface on the terminal pins is reduced to a minimum using this procedure.

In a preferred design of the invention at hand, that area of the terminal pin, which is wound with the end section of the winding wire, is immersed in a soldering bath. A soldering flux is typically used for this purpose in order to ensure a reliable solder connection.

In the first version of the invention at hand, the soft-solder is then blown off of the partial area of that area wound, which forms the soldering application surface for surface mounting by using an inert process gas.

In the second version of the invention at hand, a reducing process gas is used instead of an inert process gas. However, mixtures of various inert and/or reducing process gases are also suitable.

The use of such a process gas, at minimum an inert process gas, but even better a reducing process gas, the formation of oxide skin, i.e., the formation of so-called “soldering waste” can be avoided.

In a particularly preferred design of the invention at hand, the process gas, or the process gas mixtures, are pre-heated so that thermo-mechanical damages to the soldering points can practically be eliminated.

In order to ease the soldering process, winding wires made of varnished copper wire with pre-tinned end sections are preferred. This enables a soldering process at low temperatures, i.e., temperatures around 250° C., which allows for the use of plastics for the casing, or for the coil bodies arranged in the casing, which have a lower temperature resistance. In particular, polycarbonates and polyamides may be used in this process.

By applying the inventive process, further expansion of so-called soldering bridges can be avoided between the neighboring terminal pins. Soldering bridges do not necessarily impair coplanarity, however, they must certainly be avoided at all cost.

### BRIEF DESCRIPTION OF THE FIGURES

Examples of the invention are described in the following drawings. They show:

FIG. 1 the first partial step of the inventive process in perspective view;

FIG. 2 the second partial step of the inventive process in perspective view;

FIG. 3 an enlarged view of a section from FIG. 2 before the performance of the second partial step of the inventive process, and

FIG. 4 an enlarged view from FIG. 2 after the performance of the second partial step of the inventive process.

### DETAILED DESCRIPTION OF SPECIFIC EMBODIMENTS OF THE INVENTION

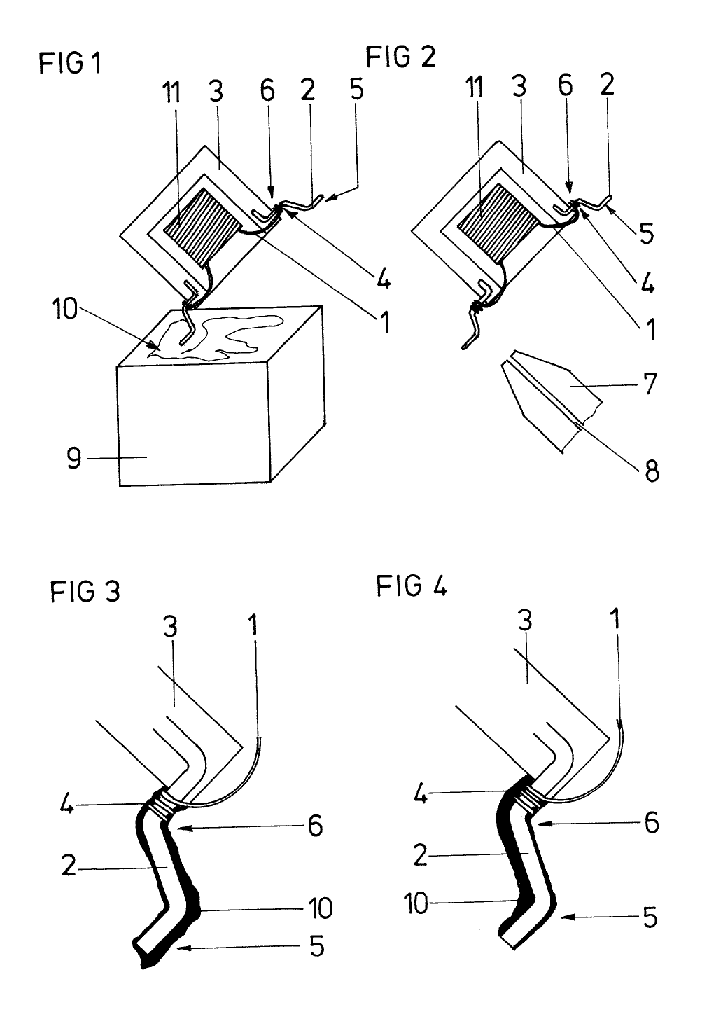

As FIG. 1 shows, an inductive SMD component is supplied for the conversion of the invention at hand, which possesses a casing 3 that houses a coil 11 in its interior.

The coil 11 consists of a winding wire 1, which is usually wound around a soft-magnetic core (not shown). Both end sections 4 of the winding wire are protruding from the interior of the casing, and wound around the rear areas of the terminal pins 2 protruding from the casing 3. The terminal pins 2 in the example shown are bent in a wing-shape. Such terminal pins are known as Gull-Wing pins.

The area of the terminal pin 2 wound with the end section 4 of the winding wire 1 is soft-soldered 10 as shown in FIG. 1. For this purpose, the terminal pin 2 is immersed in a soldering bath 9 filled with melted soft-solder so that the soft-solder 10 firmly connects the winding wire 1 to the terminal pins 2. The terminal pins 2 were first dipped in a soldering flux (not shown) in order to ensure an optimal soldering connection.

Then the soft-solder 10 is blown off of the partial areas 6 of the wound areas of the terminal pins 2, which form the soldering application surface 5 for surface mounting as shown in FIG. 2. For this purpose, a pre-heated process gas 8 is directed to the partial areas 6 through a nozzle 7. The process gas used in this example is argon.

FIG. 3 clearly shows that the soft-solder 10 covers the entire area of the terminal pins 2 located at the exterior of the casing 3 before the blowing process. This results in a very bad coplanarity of the individual terminal pins.

After the blowing process of the soft-solder 10 from the partial areas 6 of the wound areas of the terminal pins 2, which form the soldering application surface 5 for surface mounting, excess soft-solder is only evident on the opposite surfaces of the terminal pins 2, which form the soldering application surface 5 as shown in FIG. 4.

In the inductive SMD component shown, a varnished copper wire was used for the winding wire, and polyamide was used for the casing. The irregular soldering application values were reduced from 0.050 to 0.3 mm to values less than 0.020 mm in the soldering connections relating to the invention.

The inventive process can be performed using a variety of soldering techniques, and offers excellent results in all types of components, especially SMD components. It can therefore be used in the manufacture of inductive components, such as transformers, or reactors, and in the manufacture of electromechanical components, such as relays, alike.

We claim:

1. A process for connecting a winding wire of a coil with a terminal pin of a casing for surface mounting, whereby an end section of the winding wire is wound around the terminal pin in the following steps:
a partial area of the terminal pin wound with the end section of the winding wire is soft-soldered, and
the soft-solder is blown off of that partial area of the wound area, which forms the solder application surface for surface mounting.

2. The process according to claim 1, in that a terminal pin bent in a wing-shape is used.

3. The process according to claim 1, in that the area of the terminal pin wound with the end section of the winding wire is immersed in a bath of soft-solder.

4. The process according to claim 1, in that the soft-solder is blown off of the partial area of the wound area, which forms the soldering application surface for surface mounting by using an inert process gas.

5. The process according to claim 1, in that the soft-solder is blown off of the partial area of the wound area, which forms the soldering application surface for surface mounting by using a reducing process gas.

6. The process according to claim 4, in that mixtures of various inert and/or reducing process gases are used.

7. The process according to claim 5, in that mixtures of various inert and/or reducing process gases are used.

8. The process according to claim 4, in that the process gas is pre-heated.

9. The process according to claim 5, in that the process gas is pre-heated.

10. The process according to claim 1, wherein the winding wire has a pre-tinned end section that is wound around the terminal pin.

11. The process according to claim 1, in that the area of the terminal pin wound with the end section of the winding wire is dipped in a soldering flux before soft-solder is applied.

12. The process according to claim 1, in that the winding wire comprises a varnished copper wire.

13. The process according to claim 1, in that the coil is wound around a soft-magnetic core.

14. Use of a process according to claim 1 wherein several terminal pins of a component for surface mounting are connected simultaneously.

15. Use of a process according to claim 14, wherein any soldering bridges that are formed between neighboring terminal pins are blown off.
